(19) United States
(12) Patent Application Publication
(10) Pub. No.: US 2025/0086797 A1
(43) Pub. Date: Mar. 13, 2025

(54) MULTISPECTRAL IMAGE RECOGNITION METHOD AND APPARATUS, STORAGE MEDIUM, ELECTRONIC DEVICE AND PROGRAM

(71) Applicant: BeijingKeeyooTechnologiesCo.,Ltd, Beijing (CN)

(72) Inventors: Jincan Zhu, Haidian District (CN); Congxing Ouyang, Haidian District (CN); Zan Song, Haidian District (CN)

(21) Appl. No.: 18/833,212

(22) PCT Filed: Aug. 19, 2022
(86) PCT No.: PCT/CN2022/113707

§ 371 Date: Jul. 25, 2024

(30) Foreign Application Priority Data
Jan. 28, 2022 (CN) 202210109759.8

(51) Int. Cl. G06T 7/00; G06T 5/50; G06T 7/11; G06T 17/00

(52) U.S. Cl. CPC G06T 7/0014; G06T 5/50; G06T 7/11; G06T 17/00; G06T 2207/10036; G06T 2207/20021; G06T 2207/20221; G06T 2207/30036; G06T 2207/30096

(57) ABSTRACT

The present application discloses a multispectral image recognition method and apparatus, a storage medium, an electronic device and a computer program, and the method comprises: acquiring a visible light image and a non-visible light image of an oral cavity by using a camera module; fusing the visible light image and the non-visible light image to generate a fused image; dividing the fused image into oral cavity blocks according to the fused image; locating a lesion area according to a lesion block in a result of the dividing. By implementing the present application, a camera module is used to acquire a visible light image and a non-visible light image of an oral cavity; the visible light image and the non-visible light image are fused to generate a fused image, wherein the generated fused image contains spectrum information of visible light and spectrum information of non-visible light; therefore, when detection is carried out on the basis of the fused image, the accuracy of detection can be improved by means of the multispectral information contained in the image; finally, the locating is performed according to the detection result and the block dividing of the oral cavity image, thereby achieving automatic locating of a specific lesion region.

This application claims the priority of Chinese patent application with the application number of 202210109759.8, filed to CNIPA on Jan. 28, 2022, and entitled “multispectral image recognition method and apparatus, and storage medium”, the entire contents of which are incorporated herein by reference.

### TECHNICAL FIELD

The present application relates to the technical field of image processing, in particular relates to a multispectral image recognition method and apparatus, a storage medium, an electronic device and a computer program.

### TECHNICAL BACKGROUND

At present, dental diseases have increasingly become a main type of diseases that plague people. Common dental diseases comprise gingivitis, pulpitis, apical periodontitis, periodontitis, dental caries, pericoronitis of wisdom tooth, dentin hypersensitivity, odontoneuralgia and tooth injury, all of which can cause toothache. According to news media reports, the incidence rate of gingivitis is as high as 90%, the incidence rate of periodontitis is 50-70%, and the incidence rate of dental caries in children is 80-90%.

However, at present, dental diseases or tooth lesions usually require manual diagnosis by dentists. In the process of manual diagnosis, it may be necessary to collect the image information of the inside of the patient's oral cavity by oral endoscope, or to display images of the patient's oral cavity, so that the dentist can diagnose the patient's oral lesions according to the displayed images. However, this method of diagnosis by manual work is inefficient. At the same time, even with the help of tools for diagnosis, it is impossible to locate the tooth lesion automatically.

### SUMMARY OF THE INVENTION

In view of this, the embodiments of the present application provide a multispectral image recognition method and apparatus, a storage medium, an electronic device and a computer program, so as to solve the technical problem in the prior art that a tooth lesion region cannot be automatically located.

The technical schemes provided by the present application are as follows:

A first aspect of the embodiments of the present application provides a multispectral image recognition method, which comprises the following steps: acquiring a visible light image and a non-visible light image of an oral cavity by using a camera module; fusing the visible light image and the non-visible light image to generate a fused image; dividing the fused image into oral cavity blocks according to the fused image; locating a lesion area according to a lesion block in a result of the dividing.

Optionally, the step of dividing the fused image into oral cavity blocks according to the fused image comprises: matching the fused image with images of blocks in an image frame database; if a mapping relationship between the fused image and the blocks in the image frame database is determined, determining a location of the fused image in an image contour in the image frame database according to the mapping relationship; reconstructing the fused image at the determined location in the image contour to obtain reconstructed image data.

Optionally, the step of dividing the fused image into oral cavity blocks according to the fused image further comprises: comparing spectral characteristic parameters of the fused image with spectral characteristic parameters of a standard oral cavity image to obtain difference values of spectral characteristic parameters; according to a relationship between the difference values of spectral characteristic parameters and a tooth lesion, obtaining a lesion block and a non-lesion block.

Optionally, the step of locating a lesion area according to a lesion block in a result of the dividing comprises: determining a location information of the lesion block according to the reconstructed image data; locating the lesion area according to a correlation between the location information of the lesion block and a tooth region.

Optionally, the step of locating the lesion area according to a correlation between the location information of the lesion block and a tooth region comprises: displaying an updated three-dimensional image according to the reconstructed image data; labeling a lesion region in the updated three-dimensional image according to the correlation between the location information of the lesion block and the tooth region.

Optionally, the step of fusing the visible light image and the non-visible light image to generate a fused image comprises: performing binocular stereo matching according to the visible light image to generate an RGBD image in which a depth image and the visible light image are fused; registering and fusing the RGBD image and the non-visible light image to generate the fused image.

Optionally, the step of performing binocular stereo matching according to the visible light image to generate an RGBD image in which a depth image and the visible light image are fused comprises: performing parameter calibration on the camera module that acquires the visible light image; performing distortion correction and stereo paired epipolar rectification on the calibrated image to obtain a corrected image; obtaining a disparity map by stereo vision matching according to the corrected image; converting the disparity map to obtain a depth image; selecting one visible light image according to the image quality thereof, and fusing the selected visible light image and the corresponding depth image to generate the RGBD image.

Optionally, the step of registering and fusing the RGBD image and the non-visible light image to generate the fused image comprises: performing parameter calibration on the camera module that acquires the non-visible light image; calculating an offset of the non-visible light image relative to the RGBD image; superposing the non-visible light image onto the RGBD image according to the offset to generate the fused image.

A second aspect of the embodiments of the present application provides a multispectral image recognition apparatus that comprises: an image acquisition module, configured to acquire a visible light image and a non-visible light image of an oral cavity by using a camera module; a fusion module, configured to fuse the visible light image and the non-visible light image to generate a fused image; a division module, configured to divide the fused image into oral cavity blocks according to the fused image; a location module, configured to locate a lesion area according to a lesion block in a result of the dividing.

A third aspect of the embodiments of the present application provides a computer-readable storage medium, wherein computer instructions are stored in the computer-readable storage medium, and the computer instructions are configured to cause a computer to execute the multispectral image recognition method according to the first aspect and any implementation way of the first aspect of the embodiments of the present application.

A fourth aspect of the embodiments of the present application provides an electronic device, comprising a memory and a processor, wherein the memory and the processor are in communicational connection with each other; the memory has computer instructions stored therein; and the processor is configured to execute the computer instructions to perform the multispectral image recognition method according to the first aspect of the present application.

A fifth aspect of the embodiments of the present application provides a computer program, wherein, when the computer program is executed, the multispectral image recognition method according to the first aspect of the present application is implemented.

The technical schemes provided by the present application have the following effects:

The multispectral image recognition method and apparatus, the storage medium, the electronic device and the computer program provided by the embodiments of the present application adopt a camera module to acquire a visible light image and a non-visible light image of an oral cavity; fuse the visible light image and the non-visible light image to generate a fused image, wherein the generated fused image contains spectrum information of visible light and spectrum information of non-visible light; therefore, by dividing the fused image into blocks, the accuracy of detection can be improved by means of the multispectral information contained in the image; finally, the locating is based on the correlation between the lesion block and the tooth region, thereby achieving automatic locating of a specific lesion region.

### BRIEF DESCRIPTION OF APPENDED DRAWINGS

In order to explain the technical solutions in the specific embodiments of the present application or in the prior art more clearly, the appended drawings needed in the description of the specific embodiments or the prior art will be briefly introduced below. Apparently, the appended drawings in the following description only represent some embodiments of the present application. For a person skilled in the art, other drawings can be obtained according to these appended drawings without expenditure of creative labor.

FIG. 1 is a flowchart of a multispectral image recognition method according to an embodiment of the present application;

FIG. 2 is a flowchart of a multispectral image recognition method according to another embodiment of the present application;

FIG. 3 is a schematic diagram of a signal feature subspace formed when a lesion occurs;

FIG. 4 is a schematic diagram of a signal feature subspace used when detecting a visible light image and a non-visible light image respectively;

FIG. 5 is a schematic diagram of a signal feature subspace used when joint detection based on multi-spectrum is performed according to an embodiment of the present application;

FIG. 6 is a flowchart of a multispectral image recognition method according to another embodiment of the present application;

FIG. 7 is a structural block diagram of a multispectral image recognition apparatus according to an embodiment of the present application;

FIG. 8 is a schematic structural diagram of a computer-readable storage medium provided according to an embodiment of the present application;

FIG. 9 is a structural schematic diagram of an electronic device provided according to an embodiment of the present application.

### DETAILED DESCRIPTION OF SPECIFIC EMBODIMENTS

In order to make the purpose, technical scheme and advantages of the embodiments of the present application clearer, hereinafter, the technical schemes in the embodiments of the present application will be described clearly and completely with reference to the appended drawings. Apparently, the described embodiments only represent part of the embodiments of the present application, not all of them. Based on the embodiments described in the present application, all other embodiments obtainable by a person skilled in the art without expenditure of creative labor belong to the protection scope of the present application.

In practice, users often have the need to view the image of the oral cavity. For example, when a tooth hurts or a tooth is broken, the image of the inside of the oral cavity can be obtained by scanning the oral cavity by using an oral endoscope. However, in the prior art, after scanning the oral cavity, only a partial image can be obtained, but the overall three-dimensional image cannot be presented, so users cannot see the overall three-dimensional image of their own oral cavity, and they cannot determine where the broken tooth or the problematic region is located in the oral cavity. Therefore, at present, the lesional tooth can be seen from the scanned images, but the specific location of the lesion region cannot be determined therefrom, or the location information of the specific lesion region can only be manually identified and recorded by oral medical staff.

In order to improve the efficiency of manual diagnosis, the diagnosis of lesional tooth with tools has become a mainstream diagnosis method. In the process of dental caries, tooth enamel will change in color, shape and texture. Wherein, the enamel of a healthy tooth surface is translucent enamel. After the occurrence of dental caries, it will turn into white fog color, or chalky white, which is a kind of opaque white. Turning white means that the enamel is demineralized. After that, with the development of dental caries, it will become light yellow, dark brown and even black. At the same time, after the occurrence of dental caries, the complete tooth surface may become defective. Moreover, the enamel of a healthy tooth surface is very hard and smooth. After the occurrence of dental caries, the enamel on the tooth surface will soften. Therefore, during the examination, a probe is used to check the tooth surface, and if it is detected that the texture of the tooth surface becomes soft, it means that dental caries has occurred. It can be seen that the characterization of dental diseases such as caries is not limited to a single aspect, but has comprehensive characteristics in many aspects.

In addition, in the dental clinic equipment market, near infrared, ultraviolet, laser, polarized light and other dental caries detection means can obtain better specificity than visible light for detecting dental caries lesions. In particular, these means are beneficial for finding superficial dental caries and dental caries on neighboring surfaces of adjacent teeth, and for improving the sensitivity and accuracy of dental caries screening. For example, in the patent literature with the application number of 201910462922.7 and the publication number of CN110200588A, a dental caries observer is disclosed, which uses a near infrared camera to detect dental caries.

Although there are many technical schemes that can diagnose dental caries in the prior art, there are still some problems in the current schemes. Firstly, multispectral information of non-visible light and visible light is not fused for multi-parameter joint detection, which makes the detection accuracy limited and prone to misjudgment and missed detection. Secondly, after the diagnosis of the lesion area, it cannot automatically report the specific region where the lesion area of the tooth is located, and cannot determine which tooth surface of which tooth the lesion occurs on, and it still needs a professional to give the specific location information by manual identification.

In view of this, the embodiments of the present application provide a multispectral image recognition method, so as to solve the technical problem in the prior art that oral medical staff need to manually identify the lesion region.

According to the embodiments of the present application, a multispectral image recognition embodiment is provided. It should be noted that the steps shown in the flowcharts of the appended drawings can be executed in a computer system such as comprising a set of computer-executable instructions, and although the logical order is shown in the flowchart, in some cases, the steps shown or described can be executed in a sequence different from what is described herein.

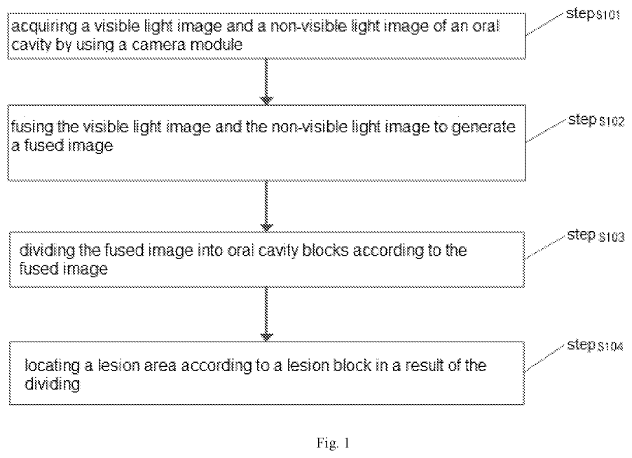

In this embodiment, a multispectral image recognition method is provided, which can be applied to electronic devices, such as computers, mobile phones, tablet computers, etc. FIG. 1 is a flowchart of the multispectral image recognition method according to an embodiment of the present application, as shown in FIG. 1, the method comprises the following steps:

The embodiments of the present application provide a multispectral image recognition method, as shown in FIG. 1, the method comprises the following steps:

Step S101: acquiring a visible light image and a non-visible light image of an oral cavity by using a camera module.

Wherein, the camera module comprises a visible light depth camera module and a non-visible light sensing module. For the visible light depth camera module, it has the perception ability of image depth information. In an embodiment, the visible light depth camera module is any one of a binocular camera module, a trinocular camera module, a multi-ocular camera module and a light field camera module, and in addition, the visible light depth camera module can also be other camera modules that can realize the visible light depth photographing function, which is not limited by the embodiments of the present application.

For the non-visible light sensing module, it has the ability of sensing non-visible light information, such as millimeter wave sensing module, far infrared camera module, infrared camera module, ultraviolet camera module, deep ultraviolet camera module and other frequency band signal sensing modules. In addition, the non-visible light sensing module can be a single frequency band signal sensing module or a combination of several frequency band sensing modules. When several frequency bands are combined, it can be a combined sensing module composed of an infrared camera module and an ultraviolet camera module, or it can be a combination of camera modules of other frequency bands.

In one embodiment, the camera module for acquiring a visible light image and a non-visible light image of the oral cavity comprises a binocular visible light depth camera module and an infrared camera module. In addition, during image acquisition, besides the camera module, a light source can also be set to provide illumination for the camera module, and the light source may be an LED light source or other types of light sources, which is not limited by the embodiments of the present application.

When acquiring the image of the inside of the oral cavity, a camera unit composed of a single camera module may be used to shoot the inside of the oral cavity, or a camera unit composed of a plurality of camera modules may be used to shoot. Wherein, the single camera module comprises a visible light depth camera module part and a non-visible light sensing module part. Images of any region inside the oral cavity can be obtained by the camera unit. In order to obtain images of all regions inside the oral cavity, a camera unit can be used to scan the inside of the oral cavity, so as to obtain a plurality of images covering all regions inside the oral cavity.

Moreover, the image data contained in the visible light image or the non-visible light image acquired by the camera module is a curved surface with a small area. Therefore, after all images or a certain number of images are acquired, the corresponding visible light images and non-visible light images are first spliced to obtain spliced visible light image blocks and spliced non-visible light image blocks. Wherein, visible light image blocks comprise image blocks that have been successfully spliced and image blocks that have not been successfully spliced. A successfully spliced image block is an image block formed by splicing a plurality of images, and an unsuccessfully spliced image block contains single image data. Similarly, non-visible light image blocks also comprise corresponding data blocks. In addition, if a certain number of images are acquired and processed at a time, the images that have not been successfully spliced can be saved firstly, and then, when images are processed after the next acquisition, the newly acquired images and the previous images that have not been successfully spliced can continue to be spliced.

Step S102: fusing the visible light image and the non-visible light image to generate a fused image. After obtaining the visible light image and the non-visible light image, they can be fused to obtain the fused image. By fusing visible and non-visible light images, the fused image can comprise not only visible light spectrum information but also non-visible light spectrum information. Therefore, when the fused image is used for detecting lesions, the characteristics of tooth lesions can be extracted from a richer parameter system, thereby further improving the detection accuracy.

Wherein, when the visible light image and the non-visible light image are fused, the visible light image and the non-visible light image of each region are fused. For example, the visible light image and the non-visible light image of the corresponding region A are fused. In order to facilitate the fusion, two images with the same time stamp can be fused based on the time stamps of the images. For example, the obtained visible light image data comprises P(1), P(2), P(3), P(4), P(5) and P(6); the obtained non-visible light images comprise L(1), L(2), L(3), L(4), L(5) and L(6); wherein, P(1) and L(1) are two images with the same time stamp, which can be fused to get a fused image. Similarly, other images with the same time stamp are fused.

In addition, it is also possible that, every time the visible light image and the non-visible light image of one region are acquired, they are fused and the subsequent detection process is performed. However, in order to improve the processing efficiency, after all the images of an oral cavity are acquired or after a certain number of images are acquired, fusion and subsequent detection process are then performed.

Specifically, the fusion process can be to fuse the spliced images, in other words, to fuse a plurality of visible light image blocks and a plurality of non-visible light image blocks. Therefore, the fused image may also comprise a plurality of fused image blocks.

Step S103: dividing the fused image into oral cavity blocks according to the fused image. By oral cavity block dividing, all the generated fused images can be divided into a plurality of oral cavity blocks, which can be divided into normal blocks and lesion blocks, and the location information of the corresponding blocks is obtained.

Step S104: locating a lesion area according to a lesion block in a result of the dividing. Specifically, by extracting the lesion block from the result of the dividing, specific lesions can be located based on the correlation between the lesion block and tooth region.

The multispectral image recognition method provided by the embodiments of the present application adopts a camera module to acquire a visible light image and a non-visible light image of an oral cavity; fuses the visible light image and the non-visible light image to generate a fused image, wherein the generated fused image contains spectrum information of visible light and spectrum information of non-visible light; therefore, by dividing the fused image into blocks, the accuracy of detection can be improved by means of the multispectral information contained in the image; finally, the locating is based on the correlation between the lesion block and the tooth region, thereby achieving automatic locating of a specific lesion region.

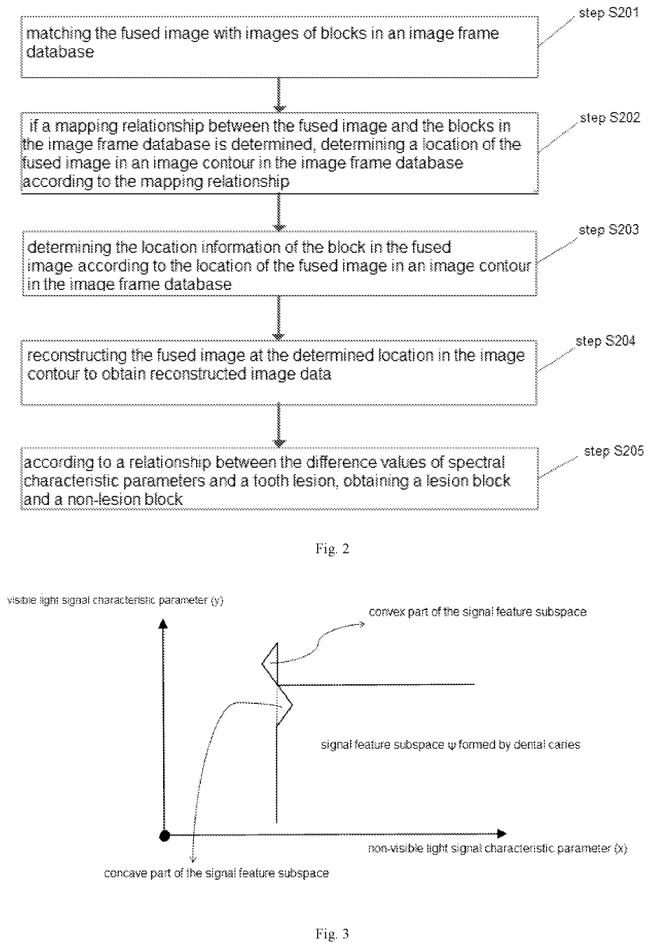

In an embodiment, as shown in FIG. 2, dividing the fused image into oral cavity blocks according to the fused image comprises the following steps:

Step S201: matching the fused image with images of blocks in an image frame database. Specifically, the image frame database is constructed based on various situations of human oral cavity. The image frame database stores the general frame data of the image model of human oral cavity, which covers the image feature information of all surface areas of human oral cavity in various situations, such as shape features, color features, texture features and other information. The image frame database stores the image data of the blocks into which the image frame images are divided and the location information of the image of each block; The location information of the images of the blocks comprises: a spatial location relationship between respective blocks; The image data of a block comprises serial number information and image feature information. Image contour stores the shape contour data of three-dimensional image of each area (including each block) on the entire inner surface of human oral cavity. Wherein, a user's image contour at least stores the shape contour data of the image of each block in the user's oral cavity.

Wherein, the fused image is obtained by fusing the spliced visible light image and the spliced non-visible light image, so that the fused image comprises a plurality of image data blocks. When matching, the image data blocks in the fused image are respectively matched with the images of the blocks in the image frame database.

Step S202: if a mapping relationship between the fused image and the blocks in the image frame database is determined, determining a location of the fused image in an image contour in the image frame database according to the mapping relationship. Specifically, if the matching is successful, the location of the fused image in the image contour in the image frame database is determined according to the mapping relationship between the fused image and the blocks in the image frame database. When determining the location, at least according to the image feature information of the blocks in the image frame database, the blocks in the image frame database corresponding to the image data blocks contained in the fused image are determined, and then the corresponding locations of the fused image data blocks in the user's image contour is determined according to the blocks in the image frame database corresponding to the image data blocks contained in the fused image.

Of course, the location in the user's three-dimensional image contour can also be determined in combination with the spatial location relationship between blocks and/or numbering information, as well as the spatial location relationship between image data blocks, which is not limited in the embodiments of the present application.

Step S203: reconstructing the fused image at the determined location in the image contour to obtain reconstructed image data. Specifically, according to the boundary feature information of blocks in the image frame database, extracting a curved surface image belonging to the corresponding block from an image data block contained in the fused image; replacing the image at the corresponding determined location in the image contour with the extracted curved surface image to obtain the reconstructed three-dimensional image data.

After reconstruction, the reconstructed image data can also be used to replace the image at the corresponding determined location in the currently saved image model. In this way, every time the reconstructed image data is obtained, the image at the corresponding location in the image model can be continuously replaced, and the effect of dynamically updating the image model can be realized. According to the updated image model, the image contour corresponding to the updated image model is obtained, and the saved image contour is updated according to the image contour corresponding to the updated image model.

Step S204: comparing spectral characteristic parameters of the fused image with spectral characteristic parameters of a standard oral cavity image to obtain difference values of spectral characteristic parameters. Specifically, the spectral characteristic parameters comprise color, texture, curved surface shape and other characteristic parameters. The characteristic parameters comprise not only the characteristic parameters of visible light spectrum, but also the characteristic parameters of non-visible light spectrum. Then, the characteristic parameters of the two kinds of spectra are fused, and then compared with the spectral characteristic parameters of a standard oral cavity image to obtain difference values of spectral characteristic parameters. The spectral characteristic parameters of the standard oral cavity image are the spectral characteristic parameters of the image of the oral cavity without lesions.

Step S205: according to a relationship between the difference values of spectral characteristic parameters and a tooth lesion, obtaining a lesion block and a non-lesion block. Specifically, visible light images and non-visible light images of teeth with various lesions may be obtained first and be fused, and then the spectral characteristic parameters of the fused images may be compared with standard oral cavity images to obtain the difference values of spectral characteristic parameters, so as to obtain the relationship between the difference values of spectral characteristic parameters and the corresponding lesions. When the current difference values of spectral characteristic parameters are obtained according to the previous step, they are substituted into this relationship for matching, and it is judged whether each block in the fused image is a lesion block, and if it is a lesion block, the corresponding lesion type can also be determined. Wherein, the lesion types include dental caries, dental calculus, dental plaque, exposed parts of tooth root after gingival atrophy, dental cracks, gingival atrophy, and so on.

Because the fused image comprises a plurality of image blocks, when calculating the difference values of spectral characteristic parameters and determining the relationship with tooth lesions, the image blocks can be directly compared, and then the image blocks can be classified according to the comparison results to obtain the lesion blocks and the non-lesion blocks. Wherein, the lesion blocks can further be classified into blocks of each lesion type.

Wherein, when the fused image is used for joint detection, the detection is actually carried out in the RGBDH signal space. In this fused image, each pixel contains signal intensity signals of four frequency points: R, G, B and H of each pixel. If there are n sampling frequency points outside the visible light band, the signal space of the fused image is RGBDH1H2 . . . Hn image. In this signal space, each pixel has signal intensity signals of (n+3) frequency points, including R, G, B, H1, H2, . . . , Hn.

Compared with the way of detecting by using visible light images and non-visible light images separately, detecting by using the fused image can improve the detection accuracy. For example, if the lesion is dental caries, although the color of early dental caries has not changed, there will be a loss of luster in the texture of the tooth surface, and at the same time, there will be some changes in frequency points beyond the visible light band, such as changes in spectral parameters such as that of infrared light or ultraviolet light. Therefore, detecting by using the fused image can integrate the image signal space of RGBDH1H2 . . . Hn to extract and cluster the characteristic parameters, thus reducing the missed detection rate and false detection rate of dental caries and improving the detection accuracy.

For example, when the lesion is dental caries, the signal feature subspace ψ formed by it is shown in FIG. 3. When reduced-dimensional images are used for detection, as shown in FIG. 4, visible light detection is processed in RGBD space and infrared detection is processed in H space. For a convex part of the signal feature subspace formed by dental caries, the visible light signal characteristic parameter y alone shows no dental caries, and the non-visible light signal characteristic parameter x alone shows no dental caries, either. When the lesion location module synthesizes the previous results, the final result will be no dental caries due to the lack of (x, y) joint detection information in the previous separate detections. In this way, the convex part of the signal feature subspace formed by dental caries becomes the missed detection area. For a concave part of the signal feature subspace formed by dental caries, the visible light signal characteristic parameter y alone shows dental caries, and the non-visible light signal characteristic parameter x alone shows dental caries, too. When the lesion location module synthesizes the previous results, the final result will be caries because of the lack of (x, y) joint detection information in the previous separate detections. In this way, the concave part in the signal feature subspace formed by dental caries becomes the false detection area.

If the fused image is used for joint detection, as shown in FIG. 5, the RGBDH image after fusion and registration is processed for detection based on the joint detection information (x, y) of the visible light signal characteristic parameter y and the non-visible light signal characteristic parameter x. Therefore, the feature subspace Φ2={x, y|(x, y)∈φ} formed by using the fused images for joint detection can fully fit the signal feature subspace ψ formed by the patient's tooth lesions.

The multispectral image recognition method provided by the embodiments of the present application can obtain the image coordinates of the lesion area, and then can automatically identify the lesional tooth region, that is, which tooth surface of which tooth is lesional. Wherein, when detecting, the color parameter characteristics and texture parameter characteristics of visible light spectrum and the spectral parameter characteristics of spectrum beyond visible light band (such as infrared light and ultraviolet light) are integrated for extracting the characteristics of tooth lesions from a richer parameter system. That is, the accuracy of dental caries detection can be further improved by means of RGBDH image information.

In an embodiment, locating a lesion area according to a lesion block in a result of the dividing comprises: determining a location information of the lesion block according to the reconstructed image data; locating the lesion area according to a correlation between the location information of the lesion block and a tooth region. Specifically, when locating, the lesion blocks in the result of the dividing are extracted first, then the location information of the lesion blocks is determined based on the previous step, and then the lesion area is located according to the correlation between the location information and a tooth region, such as the specific tooth region corresponding to the location information, so as to obtain the specific tooth region with lesions, such as which tooth surface of which tooth has lesions.

Wherein, the step of locating the lesion area according to a correlation between the location information of the lesion block and a tooth region comprises: displaying an updated three-dimensional image according to the reconstructed image data; labeling a lesion region in the updated three-dimensional image according to the correlation between the location information of the lesion block and the tooth region. In order to locate the lesion region more clearly, the updated three-dimensional image of a relevant user can be displayed firstly, and then the lesion area can be indicated in the model by means of drawing a circle or attaching a text label in accordance with the correlation between the location information of the lesion block and the tooth region, so that the user or relevant personnel can determine the lesion area more clearly and definitely.

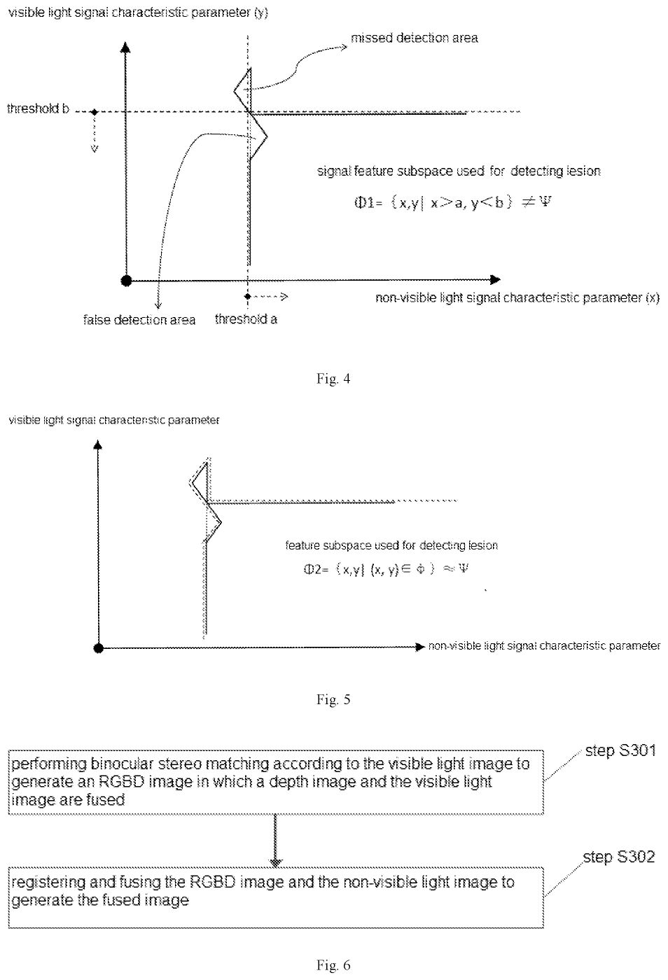

In an embodiment, as shown in FIG. 6, fusing the visible light image and the non-visible light image to generate a fused image comprises the following steps:

Step S301: performing binocular stereo matching according to the visible light image to generate an RGBD image in which a depth image and the visible light image are fused.

Specifically, in the process of fusion, firstly, performing parameter calibration on the camera module that acquires the visible light image; the parameter calibration comprises internal parameter calibration and external parameter calibration. Wherein, the internal parameter calibration is to obtain the internal parameters of the camera module, and the external parameter calibration is to obtain the external parameters of the camera module. The internal parameters reflect the projection relationship between the camera module coordinate system and the image coordinate system; The external parameters reflect the rotation R and translation T relationship between the camera module coordinate system and the world coordinate system.

After calibration, distortion correction and stereo rectification can be performed. For example, when a binocular camera module is used, distortion correction and stereo paired epipolar rectification are performed on the left and right images to obtain the corrected left and right images. Wherein, distortion correction is to correct the image by using distortion coefficient. Stereo rectification is to correct two images that are actually with non-coplanar line alignment into having coplanar line alignment.

After correction, stereo matching can be performed to generate a depth image. Specifically, firstly, a left-right disparity map is obtained by stereo vision matching according to the corrected left and right images; The visual matching can be implemented by using SGBM algorithm. After obtaining the disparity map, voids in the disparity map can be filled; Then the disparity map is converted into the corresponding depth image, such as a left-right depth image that can be converted from a binocular image.

For the obtained depth image, if a left-right depth image is obtained by converting, the quality of the left image and the quality of the right image can be judged, and one visible light image with better image quality is selected to be fused with the corresponding depth image so as to generate an RGBD image.

Step S302: registering and fusing the RGBD image and the non-visible light image to generate the fused image.

Specifically, before fusion and registration, the parameters of the camera module that acquires the non-visible light image are calibrated firstly; Similarly, the parameter calibration for non-visible light images also comprises internal parameter calibration and external parameter calibration. Then, the offset of the non-visible light image relative to the RGBD image is calculated. Then the non-visible light image is superimposed onto the RGBD image according to the offset to generate a fused image.

Wherein, the fused image contains spectral image information of visible light image and spectral image information of non-visible light image. The spectral image information of the non-visible light image may be non-visible light at a single frequency point or may also be non-visible light at a plurality of frequency points. For example, non-visible light at two frequency points of near infrared and near ultraviolet is used. Therefore, when multiple frequency points are used, the fused image is an RGBDH1H2 . . . Hn image, wherein n is the number of frequency points of the multi-frequency non-visible light thereof.

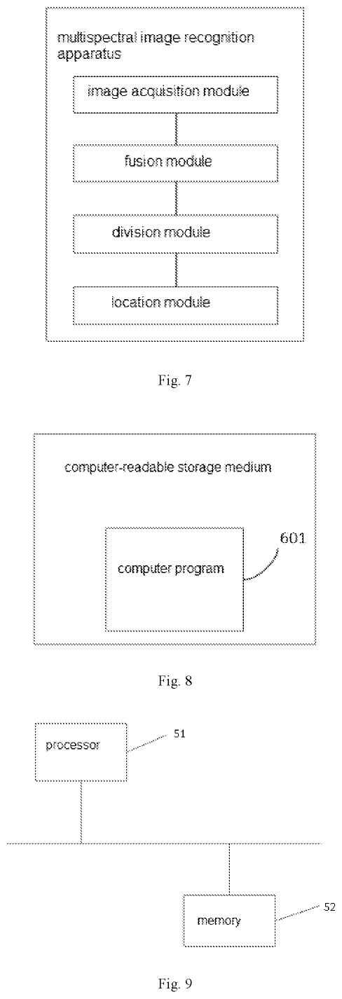

The embodiments of the present application also provide a multispectral image recognition apparatus, as shown in FIG. 7, the apparatus comprises:
an image acquisition module, configured to acquire a visible light image and a non-visible light image of an oral cavity by using a camera module; For details, please refer to the corresponding part of the above method embodiments, which will not be repeatedly described herein.
a fusion module, configured to fuse the visible light image and the non-visible light image to generate a fused image; For details, please refer to the corresponding part of the above method embodiments, which will not be repeatedly described herein.
a division module, configured to divide the fused image into oral cavity blocks according to the fused image; For details, please refer to the corresponding part of the above method embodiments, which will not be repeatedly described herein.
a location module, configured to locate a lesion area according to a lesion block in a result of the dividing. For details, please refer to the corresponding part of the above method embodiments, which will not be repeatedly described herein.

The multispectral image recognition apparatus provided by the embodiments of the present application adopts a camera module to acquire a visible light image and a non-visible light image of an oral cavity; fuses the visible light image and the non-visible light image to generate a fused image, wherein the generated fused image contains spectrum information of visible light and spectrum information of non-visible light; therefore, by dividing the fused image into blocks, the accuracy of detection can be improved by means of the multispectral information contained in the image; finally, the locating is based on the correlation between the lesion block and the tooth region, thereby achieving automatic locating of a specific lesion region.

For the functional description of the multispectral image recognition apparatus provided by the embodiments of the present application, please refer to the description of the multispectral image recognition method in the above embodiments for details.

The embodiments of the present application also provide a storage medium, as shown in FIG. 8, in which a computer program 601 is stored, and when instructions of the computer program 601 are executed by a processor, the steps of the multispectral image recognition method according to the above embodiments are implemented. The storage medium also stores audio and video stream data, feature frame data, interaction request signaling, encrypted data and preset data size. Wherein, the storage medium may be a magnetic disk, an optical disk, a Read-Only Memory (ROM), a Random Access Memory (RAM), a Flash Memory, a Hard Disk Drive (HDD) or a Solid-State Drive (SSD), etc.; The storage medium may also comprise a combination of the above kinds of memories.

It can be understood by those skilled in the art that all or part of the processes in the methods of the above embodiments can be completed by using a computer program to instruct related hardware, such a program may be stored in a computer-readable storage medium, and when executed, the program can include the processes of the above method embodiments. The storage medium may be a magnetic disk, an optical disk, a Read-Only Memory (ROM), a Random Access Memory (RAM), a Flash Memory, a Hard Disk Drive (HDD) or a Solid-State Drive (SSD), etc.; The storage medium may also comprise a combination of the above kinds of memories.

The embodiments of the present application also provide an electronic device, as shown in FIG. 9, which may comprise a processor 51 and a memory 52, wherein the processor 51 and the memory 52 may be interconnected by a bus or other means, and the connection by a bus is taken as an example in FIG. 9.

The processor 51 may be a Central Processing Unit (CPU). The processor 51 may also be other general-purpose processors, Digital Signal Processor (DSP), application specific integrated circuit (ASIC), Field-Programmable Gate Array (FPGA) or other programmable logic devices, discrete gate or transistor logic devices, discrete hardware components and other chips, or a combination of the above-mentioned chips.

As a non-transitory computer-readable storage medium, the memory 52 can be used to store non-transitory software programs, non-transitory computer-executable programs and modules, such as corresponding program instructions/modules in the embodiments of the present application. The processor 51 executes various functional applications and data processing of the processor by running the non-transitory software programs, instructions and modules stored in the memory 52, that is, the multispectral image recognition method in the above method embodiments is implemented.

The memory 52 may include a program storage area and a data storage area, wherein the program storage area may store an operation system and an application program required by at least one function; the data storage area may store data generated by the processor 51 and the like. In addition, the memory 52 may include high-speed random access memory and also include non-transitory memory, such as at least one disk memory device, flash memory device, or other non-transitory solid-state memory devices. In some embodiments, the memory 52 may optionally include memories located remotely from the processor 51, and these remote memories may be connected to the processor 51 through a network. Examples of said network include, but are not limited to, the Internet, an intranet, a local area network, a mobile communication network, and combinations thereof.

The one or more modules are stored in the memory 52 and, when executed by the processor 51, perform the multispectral image recognition method according to the embodiments shown in FIGS. 1-6.

The specific details of the above-mentioned electronic device can be understood by referring to the corresponding related descriptions and effects in the embodiments shown in FIGS. 1 to 6, and will not be repeatedly described herein.

Although the embodiments of the present application have been described in connection with the appended drawings, a person skilled in the art can still make various modifications and variations without departing from the spirit and scope of the present application, and such modifications and variations are all within the scope defined by the appended claims.

1. A multispectral image recognition method, comprising:
acquiring a visible light image and a non-visible light image of an oral cavity by using a camera module;
fusing the visible light image and the non-visible light image to generate a fused image;
dividing the fused image into oral cavity blocks according to the fused image;
locating a lesion area according to a lesion block in a result of the dividing.

2. The multispectral image recognition method according to claim 1, wherein the step of dividing the fused image into oral cavity blocks according to the fused image comprises:
matching the fused image with images of blocks in an image frame database;
if a mapping relationship between the fused image and the blocks in the image frame database is determined, determining a location of the fused image in an image contour in the image frame database according to the mapping relationship;
reconstructing the fused image at the determined location in the image contour to obtain reconstructed image data.

3. The multispectral image recognition method according to claim 1, wherein the step of dividing the fused image into oral cavity blocks according to the fused image further comprises:
comparing spectral characteristic parameters of the fused image with spectral characteristic parameters of a standard oral cavity image to obtain difference values of spectral characteristic parameters;
according to a relationship between the difference values of spectral characteristic parameters and a tooth lesion, obtaining a lesion block and a non-lesion block.

4. The multispectral image recognition method according to claim 2, wherein the step of locating a lesion area according to a lesion block in a result of the dividing comprises:
determining a location information of the lesion block according to the reconstructed image data;
locating the lesion area according to a correlation between the location information of the lesion block and a tooth region.

5. The multispectral image recognition method according to claim 4, wherein the step of locating the lesion area according to a correlation between the location information of the lesion block and a tooth region comprises:
displaying an updated three-dimensional image according to the reconstructed image data;
labeling a lesion region in the updated three-dimensional image according to the correlation between the location information of the lesion block and the tooth region.

6. The multispectral image recognition method according to claim 1, wherein the step of fusing the visible light image and the non-visible light image to generate a fused image comprises:
performing binocular stereo matching according to the visible light image to generate an RGBD image in which a depth image and the visible light image are fused;
registering and fusing the RGBD image and the non-visible light image to generate the fused image.

7. The multispectral image recognition method according to claim 6, wherein the step of performing binocular stereo matching according to the visible light image to generate an RGBD image in which a depth image and the visible light image are fused comprises:
performing parameter calibration on the camera module that acquires the visible light image;
performing distortion correction and stereo paired epipolar rectification on the calibrated image to obtain a corrected image;
obtaining a disparity map by stereo vision matching according to the corrected image;
converting the disparity map to obtain a depth image;
selecting one visible light image according to the image quality thereof, and fusing the selected visible light image and the corresponding depth image to generate the RGBD image.

8. The multispectral image recognition method according to claim 6, wherein the step of registering and fusing the RGBD image and the non-visible light image to generate the fused image comprises:
performing parameter calibration on the camera module that acquires the non-visible light image;
calculating an offset of the non-visible light image relative to the RGBD image;
superposing the non-visible light image onto the RGBD image according to the offset to generate the fused image.

9. (canceled)

10. A computer-readable storage medium, wherein computer instructions are stored in the computer-readable storage medium, and the computer instructions are configured to cause a computer to execute the multispectral image recognition method according to claim 1.

11. An electronic device, comprising a memory and a processor, wherein the memory and the processor are in communicational connection with each other; the memory has computer instructions stored therein; and the processor is configured to execute the computer instructions to perform the multispectral image recognition method according to claim 1.

12. (canceled)
